(19) United States
(12) Patent Application Publication
(10) Pub. No.: US 2018/0345498 A1
(43) Pub. Date: Dec. 6, 2018

(54) DETERMINING THE MOVEMENT OF A MACHINE TO BE SECURED

(71) Applicant: SICK AG, Waldkirch (DE)

(72) Inventor: Martin MÜNCHER, Waldkirch (DE)

(21) Appl. No.: 15/981,394

(22) Filed: May 16, 2018

(30) Foreign Application Priority Data
May 31, 2017 (DE) 102017111886.1

(51) Int. Cl. B25J 9/16; B25J 19/02

(52) U.S. Cl. CPC B25J 9/1674; B25J 9/162; B25J 19/022; B25J 9/1651

(57) ABSTRACT

An arrangement for determining the movement of a machine to be secured after safety directed emergency signal, wherein the arrangement has a sensor module and a trigger module, wherein the sensor module is subsequently and releasably fastenable to the machine, and wherein the sensor module comprises:
at least one sensor for detecting movement data describing the movement,
a first trigger interface for the reception of a trigger signal that includes the point in time of the emergency signal, and
a recording unit that is configured to store and/or output at least some of the movement data from the time period between the point in time of the emergency signal and the reaching of a safe state of the machine, and wherein the trigger module is configured for generating and/or receiving the safety directed emergency signal for the machine to be secured.

The invention relates to a sensor module for determining the movement of a machine to be secured after a safety directed emergency stop signal, in particular of a robot or of a vehicle, wherein the sensor module is subsequently and releasably fastenable to the machine and has at least one sensor for detecting movement data describing the movement. The invention further relates to a trigger module for generating and/or receiving a safety directed emergency signal at a machine to be secured and to a corresponding method of determining the movement of a machine to be secured.

It is the primary goal of safety engineering to protect persons from risks such as, for example, machines in an industrial environment represent. The machine is monitored with the aid of sensors and accordingly, if a situation is present in which a person threatens to come dangerously close to the machine, a suitable securing measure is taken.

Conventionally, primarily optoelectronic sensors such as light grids or laser scanners have been used for a safety engineering monitoring. More recently 3D cameras have been added. A common securing concept provides that protected fields are configured that may not be entered by operators during the operation of the machine. If the sensor recognizes an unauthorized intrusion into the protected field, for instance a leg of an operator, it triggers a safety directed stop of the machine. Other intrusions into the protected field, for example by static machine parts, can be taught as permitted in advance. Warning fields are frequently disposed in front of the protected fields and intrusions there initially only result in a warning to prevent the intrusion into the protected field and thus the securing in good time and so to increase the availability of the plant. Alternatives to protected fields are also known; for instance, taking care that a minimum distance is observed between the machine and the person that is dependent on the relative movement (“speed and separation”).

Sensors used in safety technology have to work particularly reliably and must therefore satisfy high safety demands, for example the EN13849 standard for safety of machinery and the machinery standard IEC61496 or EN61496 for electrosensitive protective equipment (ESPE). A number of measures have to be taken to satisfy these safety standards such as reliable electronic evaluation by redundant, diverse electronics, function monitoring or specifically monitoring the soiling of optical components, in particular of a front screen, and/or provision of individual test targets with defined degrees of reflection which have to be recognized at the corresponding scanning angles.

There is an increasing desire for closer cooperation with persons (HRC, human-robot collaboration) in the safety engineering monitoring of robots, especially lightweight construction robots. For this purpose, protected fields and safety distances should be configured to be as small as possible, naturally under the condition that safety is ensured. Due to the complexity and the lack of specifications, it is, however, extremely difficult to evaluate the system response time and the stopping or overrun distance of a robot since a large number of sensors, interfaces, field buses, and controls having individual delays cooperate here. Worst case data of the robot manufacturer are therefore made use of, with such data frequently being lacking for the overrun distance itself since the overrun distance depends on the moving mass and thus on the payload.

Consequently, the known delays of the components on the signal path are summed using very conservative estimates for the unknown delays and are multiplied by a maximum speed of the robot arm; then an overrun distance for the most unfavorable load and, where possible, also a safety margin for the insecurity of the estimates is added. Extremely long stopping times and stopping distances, and thus safety dimensions, result from this that admittedly reliably satisfy their protective function, but practically preclude a close collaboration between human and machine.

To enable a greater proximity between the robot and the collaborating human, it is advantageous for the response times relevant to a safety directed response to be minimized or for the risk of a contact to not only be avoided by a conventional switching off, but for the robot to defuse the hazard situation by an active evasion. However, this is all only of help if it is also taken into account in the safety consideration, which is not the case in the described and typical conservative procedure.

DE 10 2015 106 227 B3 discloses a method of controlling and/or regulating motors of a robot that comprises the prediction of a braking distance for safety reasons. Such a modeling is not sufficient for safety engineering since the safety dimensioning may not be directed toward an expectation, but must rather take account of the actual robot movement. The model would therefore again have to be embedded in a worst case scenario and it thereby loses the possible advantage.

In WO 2012/042470 A1, a safety apparatus for a robot is described that monitors the robot movements in a diverse manner using encoders and inertial sensors. It is thus ensured that the plan and reality coincide in the robot with respect to its movements. This is admittedly a safety aspect, but has nothing to do with the configuration of safety distances for a switching off in good time on the risk of collision with a collaborating person, particularly since this person would actually not be recognized by the safety apparatus.

A method of securing a working space that is observed by a 3D camera to recognize a deviation from a desired state is known from DE 10 2007 007 576 B4. The movements of the human and the robot are modeled for this purpose and are monitored in a safe technique in an inspection phase as to whether the robot moves as programmed. DE 10 2007 576 B4 does not, however, indicate what degree a deviation has to adopt to be safety critical and how safety distances fixing this deviation could be smaller for a closer human-machine cooperation.

It is therefore the object of the invention to improve the configuration of a safety engineering monitoring.

This object is satisfied by a sensor module and by a trigger module for determining the movement of a machine to be secured after a safety directed emergency stop signal, in particular of a robot or of a vehicle, and by a corresponding method in accordance with the respective independent method claim. The safety directed emergency signal triggers a securing of the monitored machine, with this also being able to be an evasive movement in addition to the customary braking or moving to a standstill. The sensor module is not a part of the machine, but rather a small additional device that is subsequently attached. It is able with the help of at least one sensor to detect movement data that make at least the safety relevant portion of the movement reconstructable.

The invention starts from the basic idea of measuring the actual movement of the machine after a safety directed emergency signal. For this purpose, a first trigger interface is provided for the reception of a trigger signal that communicates the point in time of the safety directed emergency signal. The transmission of the trigger signal preferably takes place wirelessly to simplify the attachment of the sensor module and to avoid disturbing lines during the movements of the machine. The sensor module records movement data in the time period between the point in time of the emergency signal designated by the trigger signal and the reaching of a safe state of the machine. Which movement data they are depends on the specific safety application or configuration of the sensor module. Simply the points in time when the movement behavior after the emergency signal changes for the first time or when the machine comes to a stop or the duration between these points in time are thus already extremely relevant to the response time or to the overrun distance.

The invention has the advantage that the behavior of the machine and the delays on the signal paths of the safety directed emergency signal are precisely determined, that is response times, overrun distances, or effects of differently moving masses are known by the sensor module. The system can therefore be configured with optimized safety distances that make possible a considerably greater proximity of human and machine. The configuration, optimization, and verification of the safety engineering used is simplified and improved. An overdimensioning of the safety distances with a conventional conservative switching off of the system to compensate unknown delays and movements is no longer necessary since it is determined by direct measurement.

The movement data preferably have at least one of the parameters position, speed, acceleration, in particular with a time stamp in each case. As already stated, it is not necessary to measure and record all these parameters over the total time duration from the point in time of the emergency signal up to the reaching of the safe state if, for example, it is only a question of determining response times. Said parameters are moreover not independent; the integration of speed vectors delivers the position shift, for example. It is, however, by all means conceivable to detect the movement behavior per se in a mathematically overdetermined manner to obtain particularly reliable data.

The sensor module preferably has an accelerometer and/or a rotation rate sensor or gyro sensor. Movement changes in all six degrees of freedom are thus determined and the movement is thus completely describable. Depending on the application, not all the degrees of freedom have to be monitored due to marginal conditions.

The sensor module is preferably energy autonomous. A battery or a rechargeable battery is, for example, provided for this purpose. A supply connection would also be conceivable in some machines. It is, however, advantageous to avoid the required lines and to be able to freely select an arrangement ideal for the measurement.

The sensor module preferably has a wireless output interface for the output of movement data. The recorded movement data would be externally available via this. For example, an app on a mobile device or on a configuration processor is connected to the sensor module. The handling is simplified by a wireless transmission. In principle, a wired output interface is also imaginable for this purpose. An output in the form of a display on the sensor module can be sufficient for some applications or a display complements the data output.

The trigger module in accordance with the invention for generating and/or receiving a safety directed emergency signal to a machine to be secured is configured to cooperate with the sensor module. It can even be a source for safety directed emergency signals generated as a test, for example on the push of a button, that are then supplied to the machine so that it responds with a safety directed braking or evading movement. The trigger module is, however, preferably connected to the path via which the machine receives safety directed emergency signals within the safety application. In this case, the trigger module only listens to learn the point in time of safety directed emergency signals.

The trigger module has a second trigger interface for the output of a trigger signal that includes the point in time of the emergency signal. The trigger module can thus forward the points in time of safety directed emergency signals to the sensor module in accordance with the invention that are there so-to-say used as the start signal for the recording of the movement in the securing case.

A time stamp for the point in time of the emergency signal is preferably encoded into the trigger signal. It is here, for example, a modulation that is understood as a point in time by the sensor module or is at least stored with the movement data. Due to the time stamp, the selection of the movement data to be recorded does not have to run in real time; it is rather the case that a trigger signal can also only subsequently indicate the relevant time period. It is naturally a requirement that the movement is monitored in the sensor module as a precaution and corresponding information is buffered. Alternatively, the trigger signal is immediately generated with the safety directed emergency signal; the point in time of the emergency signal is then directly the reception point in time of the trigger signal that in this case does not contain any further time information in it. Any latencies are negligible here and could even be measured and, for example, taken into account in time stamps of the sensor module. This alternative procedure only works in real time, but has the advantage that the sensor only has to be respectively active in the relevant phase between the emergency stop signal and the safe sate and thereby in particular uses less energy.

The second trigger interface is preferably formed as an infrared interface. It is sufficient to then transmit infrared trigger signals in an unfocused manner as with a remote control roughly in the direction of the sensor module; a special adjustment is not necessary. A different wireless transmission of the trigger signal is also conceivable; wired is admittedly possible in principle, but is practically of considerable disadvantage due to the limited freedom of movement of disturbing lines.

In a preferred further development, an arrangement is provided for determining the movement of a machine to be secured after a safety directed emergency signal, in particular of a robot or of a vehicle, with the arrangement having a sensor module in accordance with the invention and a trigger module in accordance with the invention. The sensor module and the trigger module cooperate in accordance with their intended purpose in this arrangement.

In the method in accordance with the invention of determining the movement of a machine to be secured after a safety directed emergency signal, in particular of a robot or of a vehicle, a sensor module having at least one sensor for the detection of movement data describing the movement of the machine, in particular a sensor module in accordance with the invention, is releasably attached to the machine. A safety directed emergency stop of the machine is then preferably repeatedly triggered and a trigger signal that includes the point in time of the emergency signal is transmitted to the sensor module, in particular by a trigger module in accordance with the invention. Movement data of the sensor module between the point in time of the emergency signal designated by the trigger signal and the reaching of a safe state of the machine are thereupon stored or output. The method in accordance with the invention can be further developed in a similar manner to the sensor module or trigger module and shows similar advantages in so doing. Such advantageous features are described in an exemplary, but not exclusive manner in the subordinate claims dependent on the independent claims.

The method is preferably further developed into a method for configuring and/or verifying at least one safety sensor that monitors a machine to be secured and that outputs a safety directed emergency stop signal to the machine on the falling below of a safety distance between the machine and a detected unpermitted object. For this purpose, the movement of the machine after a safety directed emergency stop signal is determined using the method in accordance with the invention and the safety distance is verified or adapted using the stored or output movement data. In this manner, optimized safety distances can be found that enable a substantially closer cooperation of human and machine with full safety, or it can be demonstrated or verified that selected safety distances actually do not signify any reductions in safety.

The invention will be explained in more detail in the following also with respect to further features and advantages by way of example with reference to embodiments and to the enclosed drawing. The Figures of the drawing show in:

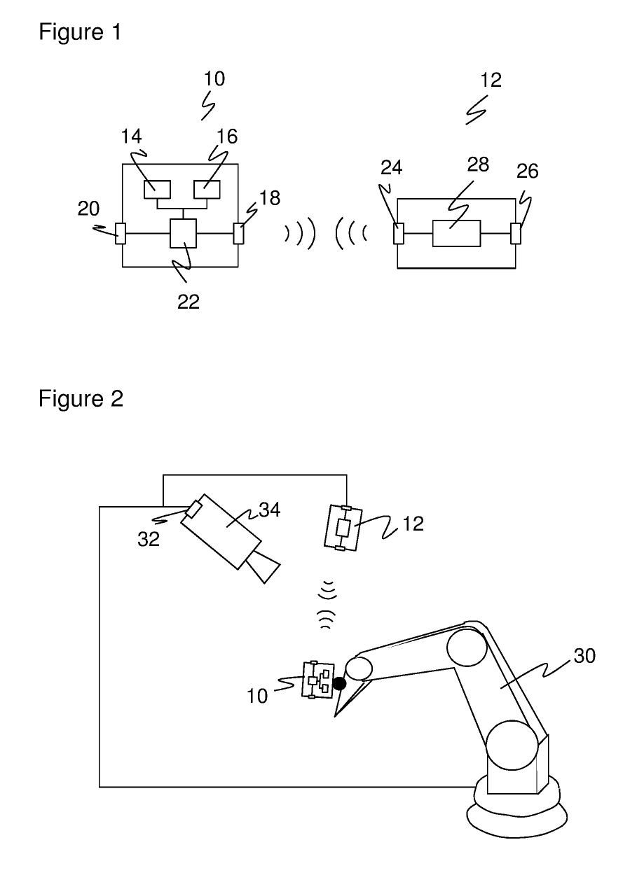

FIG. 1 a block diagram of a sensor module and of a trigger module;

FIG. 2 a schematic view of a sensor module attached to a robot and of a trigger module connected to the safety output of a monitoring safety camera; and

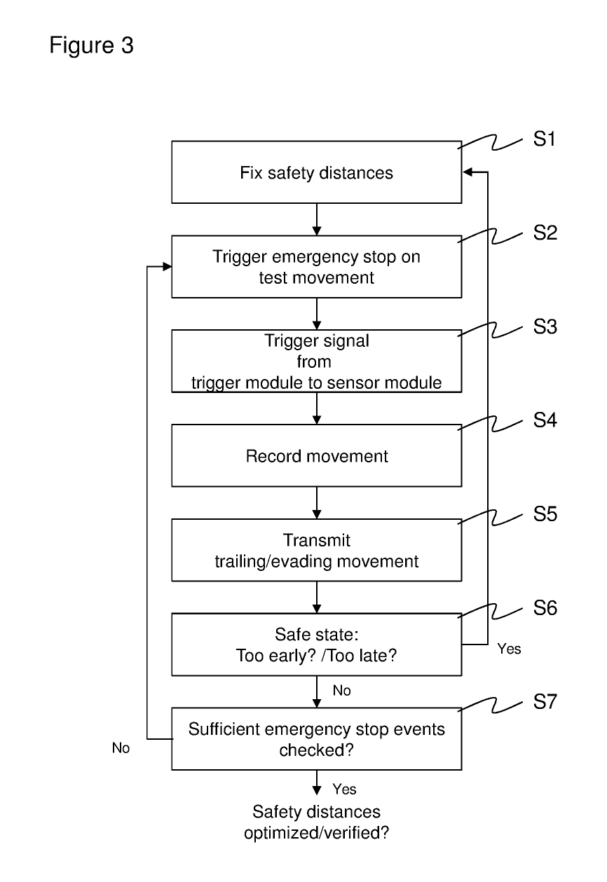

FIG. 3 a flowchart for a method of fixing safety distances with the aid of the sensor module and the trigger module.

FIG. 1 shows a block diagram of a sensor module 10 for determining the response time or the movement of a machine to be secured after a safety directed emergency stop and of an associated trigger module 12 for transmitting a trigger signal that communicates points in time of a safety directed emergency stop.

The sensor module 10 is a small device for attachment to a hazardous object. In this description, a robot is used as an example for the hazardous object, but other machines and vehicles are likewise conceivable, in particular autonomous vehicles (AGCs, automated guided carts. or AGVs, automated guided vehicles). The sensor module is subsequently and releasably attached, for example by magnets, a clamp holder, a hook and loop band, or an adhesive band, and indeed preferably in proximity to the point of greatest danger, for instance a tool tip.

The sensor module 10 has at least one sensor to detect its own movement and thus the movement of the object to which it is attached. In the embodiment in accordance with FIG. 1, an accelerometer 14 and a rotation rate sensor 16 are provided by way of example. The accelerations and rotation rates can be determined in one to three dimensions depending on the application. The instantaneous speed can be determined by integration of the acceleration vectors; the direction of movement can be determined by means of the rotation rate. These calculations take place in the sensor module 10 or subsequently. Other or additional sensor are also possible. One example is a position sensor that determines its own position using known transmitters. This technique works like GPS, but also inwardly and at a higher resolution; and instead of radio, other signals such as ultrasound are also conceivable. A sensor for determining a payload is optionally also conceivable or such additional information is polled by the machine's own sensors.

The sensor module 10 has a first trigger interface 18, preferably having an IR receiver, at which a trigger signal is recognized that displays that a safety directed emergency stop has been triggered. In addition, an output interface 20 is provided, preferably a radio interface in accordance with a standard such as wireless LAN, ZIGBEE, BLE or the like.

A recording unit 22 is connected to the sensors 14, 16 and to the interfaces 18, 20 and can also take over other control and evaluation functions in the sensor module 10. The recording unit 22 stores movement data of the sensors 14, 16 or parameters derived therefrom in a memory not shown separately, preferably whenever a trigger signal has been received.

The trigger module 12 has a second trigger interface 24, preferably having an IR laser or an IR LED, that acts as a transmitter to transmit a trigger signal to the first trigger interface 18 of the sensor module 10. An emergency signal interface 26 is furthermore present for safety directed emergency signals. This emergency signal interface 26 is configured as an input or as an output depending on the embodiment. In the first case, the trigger module is additionally connected to a line by which safety directed signals are transmitted in an existing safety application to the monitored machine (OSSD, output signal switching device). The trigger module 12 is in this manner likewise informed of safety directed emergency stops that arrive at the machine. In the second case, the trigger module itself generates safety directed emergency signals test-wise to the monitored machine, whether internally or with the aid of an actuation device such as a button. The emergency signal interface 26 here acts as a safety output (OSSD) to which the monitored machine is connected. A trigger control 28 is connected to the second trigger interface 24 and to the emergency signal interface 26.

The sensor module 10 and the trigger module 12 are preferably small with maximum dimensions of 5 cm×10 cm×2 cm and are light with a weight of at most 100 g. They can be battery operated, for instance with a fixedly installed lithium ion rechargeable battery. If all the interfaces are then also wireless, the total arrangement in the measurement principle, data paths, and supply is contactless and is particularly simple to handle. Additional functions such as a display, not shown, for status such as operation, errors, or active data connection, in particular in the form of simple LEDs, are possible.

FIG. 2 shows a schematic view of a sensor module 10 attached to a robot 30 and of a trigger module 12 connected to a safety output 32 of a monitoring safety camera 34. In this embodiment, it is therefore not the trigger module 12 itself that is the trigger of such a safety directed emergency signal, but rather the safety camera 34, and the trigger module 12 learns of this via its connection to the emergency signal interface 26.

The configuration shown in FIG. 2 is an application example that can be varied in a variety of respects. It has first already been mentioned that other machines than the robot 30 can be monitored. The monitoring here furthermore takes place from outside by the safety camera 34. The safety camera 34 is only representative for any desired optical sensors or other sensors and arrangements of sensors that monitor the robot 30 and/or its surroundings. In addition, instead of a monitoring from outside, a monitoring by a sensor is possible that is part of the robot 30 such as a camera of the robot or a capacitive skin. The safety engineering does not have to be part of the plant overall, but can be a direct component of the robot 30 itself. Combinations of external sensors and sensors of the robot 30 are also conceivable.

In order now to determine the movement of the robot 30 after a safety directed emergency signal, a situation is presented in which the safety camera 34 recognizes a hazard. Alternatively, the safety directed emergency signal is artificially initiated in the safety camera 34 or in another component, not shown.

The trigger control 28 of the trigger module 12 recognizes the safety directed emergency signal at the emergency signal interface 26 and generates a trigger signal at the second trigger interface 24. The trigger signal is preferably suitably encoded to be recognized as such or even includes a code for a time stamp of the safety directed emergency signal.

The sensor module 10 receives the trigger signal at the first trigger interface 18. From this point in time onward, movement data are generated by the accelerometer 14 and by the rotation rate sensor 16 and are stored by the recording unit 22. Alternatively, such movement data are collected and buffered constantly and the trigger signal only designates a relevant time period in which the movement data should be forwarded.

The recording unit 22 can already further process the movement data, for instance can calculate a respective instantaneous speed and direction of movement or add a time stamp. Which movement data are actually stored and later passed on is a question of the configuration and the application. As a rule, the time period of interest ends as soon as the robot 30 has reached a safe state, that is, is at a standstill or has completed an evasion movement.

The movement data stored by the recording unit 22 are subsequently forwarded via the output interface 20. This can take place, for example, after every safety directed emergency signal, after a specific number of repetitions or on request. A possible receiver of the movement data is a hand-held device such as a notebook, a tablet or a smartphone, but generally any device that is able to communicate with the output interface 20. The movement data are visualized and analyzed there and serve as a basis for further optimizations, tests, or simulations. The movement data of the sensor module 10 can also be compared or supplemented with data of the robot control, for instance by feedback sensors of the robot 30 with information on its own movement. The image data of the safety camera 34 also provide an additional information source for comparison or to improve the movement data.

FIG. 3 shows a flowchart for an exemplary optimization and/or verification of safety distances with the aid of the sensor module 10 and of the trigger module 12. The arrangement shown in FIG. 2 can here be made use of for orientation, but may not be understood as restrictive for this purpose. A verification does not only mean that a check is made whether a response was made to a hazardous situation in good time in each case. The sensor module 10 would not be needed for this; a simple test rod would suffice. Conclusions can rather also be drawn from the recorded movement data in the framework of a verification which considerably accelerate and improve the method.

Safety distances are fixed in a step S1. Since this is only an initial state, these safety distances can generally be as desired. To at least ensure the safety from the start, the initial safety distances can be selected in a very classic manner using worst case scenarios and safety margins.

A safety directed emergency signal is then triggered test-wise in a step S2. A possibility for this is to intentionally just fall below the set safety distances so that the safety application automatically reacts with an emergency signal. The safety related emergency signal can, however, also be triggered in any desired other manner, in particular actively by the trigger module 12, and useful conclusions can later also be drawn from a movement into the safe state that does not result from the borderline situation on falling below a safety distance.

In a step S3. the trigger module 12 generates a trigger signal at the point in time of the safety directed emergency stop and/or with encoded information of this point in time.

In a step S4, the sensor module 10 records its own movement as information on the movement of the machine to which it is attached. The corresponding movement data should sufficiently characterize the movement in the time period from the triggering of the emergency signal up to the reaching of the safe state. Partial information can, however, also be useful; for instance the accumulated response time of the system can be determined from the point in time when a braking and evasion movement starts and the overrun path can be determined from the end position.

In a step S5, the movement data desired for the optimization are transmitted by the sensor module 10, preferably to a hand-held device having corresponding software (app). They can be reaction times, complete movement profiles, or parts thereof.

In a sixth step S6, a check is made on the hand-held device using the transmitted movement data whether the set safety distances are optimum. Even a single case in which the safe state has been reached too late is almost always unacceptable because the health of persons depends thereon. In this case, the safety distances are too tight and not verified so that the method starts again with new safety distances in the step S1. If the safe state is reached at too early a time, this is an indication for further optimization scope for the safety distances that can be adapted in step S1. However, nothing stands in the way of a verification here; this is of no concern in a safety engineering respect and can be accepted as an ideal setting.

The previous description of the method assumes that the movement data are transmitted and evaluated directly after each safety directed emergency signal. In practice, safety directed emergency signals will preferably be generated repeatedly in different situations and will then be transmitted and evaluated in a bundle.

The method is ended in a step S7 as soon as sufficient events with safety directed emergency signals have been checked. This can be specified by statistics, for instance by an error rate corresponding to a desired standardized safety level, by a fixed number of repeats, or in that the achieved safety distances are now small enough for a sufficiently close collaboration of human and machine, or by other criteria.

1. An arrangement for determining the movement of a machine to be secured after a safety directed emergency signal, wherein the arrangement has a sensor module and a trigger module, wherein the sensor module is subsequently and releasably fastenable to the machine, and wherein the sensor module comprises:
at least one sensor for detecting movement data describing the movement,
a first trigger interface for the reception of a trigger signal that includes the point in time of the emergency signal, and
a recording unit that is configured to store and/or output at least some of the movement data from the time period between the point in time of the emergency signal and the reaching of a safe state of the machine, and wherein the trigger module is configured for generating and/or receiving the safety directed emergency signal for the machine to be secured.

2. The arrangement in accordance with claim 1,
wherein the machine is one of a robot and a vehicle.

3. The arrangement in accordance with claim 1,
wherein the movement data have at least one of the parameters position, speed, acceleration.

4. The arrangement in accordance with claim 3,
wherein the movement data have at least one of the parameters position, speed, acceleration with a time stamp in each case.

5. The arrangement in accordance with claim 1,
wherein the sensor module has at least one of an accelerometer and a rotation rate sensor.

6. The arrangement in accordance with claim 1,
wherein the sensor module is energy autonomous.

7. The arrangement in accordance with claim 1,
wherein the sensor module has a wireless output interface for the output of movement data.

8. The arrangement in accordance with claim 1,
wherein the trigger module comprises a second trigger interface for the output of a trigger signal that includes the point in time of the emergency signal.

9. The arrangement in accordance with claim 1,
wherein a time stamp for the point in time of the emergency signal is encoded into the trigger signal.

10. The arrangement in accordance with claim 1,
wherein the second trigger interface is configured as an infrared interface.

11. The arrangement in accordance with claim 1,
wherein the machine is one of a robot and a vehicle.

12. A method of determining the movement of a machine to be secured after a safety directed emergency signal, wherein
a sensor module having at least one sensor for the detection of movement data describing the movement of the machine is releasably attached to the machine;
a safety directed emergency stop of the machine is triggered;
a trigger signal that includes the point in time of the emergency signal is transmitted to the sensor module; and
movement data of the sensor module between the point in time of the emergency signal designated by the trigger signal and the reaching of a safe state of the machine is stored or output.

13. The method in accordance with claim 12,
wherein the machine is one of a robot and a vehicle.

14. The method in accordance with claim 12,
wherein the sensor module further comprises:
a first trigger interface for the reception of a trigger signal that includes the point in time of the emergency signal, and
a recording unit that is configured to store and/or output at least some of the movement data from the time period between the point in time of the emergency signal and the reaching of a safe state of the machine.

15. The method in accordance with claim 12,
wherein the trigger signal is transmitted to the sensor module by a trigger module comprising a second trigger interface for the output of said trigger signal, with said trigger signal including the point in time of the emergency signal.

16. A method of configuring and verifying at least one safety sensor that monitors a machine to be secured and that outputs a safety directed emergency stop signal to the machine on a falling below of a safety distance between the machine and a detected unpermitted object, wherein the movement of the machine is determined by a method of determining the movement of a machine to be secured after a safety directed emergency signal, wherein
a sensor module having at least one sensor for the detection of movement data describing the movement of the machine is releasably attached to the machine;
a safety directed emergency stop of the machine is triggered;
a trigger signal that includes the point in time of the emergency signal is transmitted to the sensor module; and
movement data of the sensor module between the point in time of the emergency signal designated by the trigger signal and the reaching of a safe state of the machine is stored or output after a safety directed emergency stop signal and the safety distance is verified or adapted with reference to the stored or output movement data.
